(19) United States
(12) Patent Application Publication
(10) Pub. No.: US 2026/0210989 A1
(43) Pub. Date: Jul. 23, 2026

(54) LIQUID DISPENSING WITH REDUCED DROPLET EVAPORATION

(71) Applicant: Agilent Technologies, Inc., Santa Clara, CA (US)

(72) Inventors: Richard K. Workman, Sunnyvale, CA (US); Victor Lim, Pacifica, CA (US)

(21) Appl. No.: 19/143,849

(22) PCT Filed: Dec. 19, 2023
(86) PCT No.: PCT/US2023/084898

§ 371 Date: Jun. 26, 2025

Related U.S. Application Data
(60) Provisional application No. 63/436,068, filed on Dec. 29, 2022.
(60) Provisional application No. 63/540,017, filed on Sep. 22, 2023.

(51) Int. Cl. G01N 35/10

(52) U.S. Cl. CPC G01N 35/1009

(57) ABSTRACT

Liquids are dispensed onto a substrate in a manner that reduces droplet evaporation while and after the liquids are dispensed. The substrate is at least partially enclosed by boundaries that form a chamber that is effective to reduce the rate of evaporation of droplets being dispensed. The chamber may be partially open to a surrounding environment. Additional evaporative liquid may be provided to assist in reducing the rate of evaporation. The liquid dispensing may be implemented, for example, as part of the fabrication of a microarray such as a chemical or biochemical array, which may be the product of DNA or RNA array printing.

### CROSS-REFERENCE TO RELATED APPLICATIONS

This application is the national stage under 35 U.S.C. 371 of International Application No. PCT/US2023/084898, filed Dec. 19, 2023; which claims the benefit under 35 U.S.C. § 119(e) of U.S. Provisional Patent Application Ser. No. 63/436,068, filed on Dec. 29, 2022, titled “LIQUID DISPENSING WITH REDUCED DROPLET EVAPORATION”; and U.S. Provisional Patent Application Ser. No. 63/540,017, filed on Sep. 22, 2023, titled “LIQUID DISPENSING WITH REDUCED DROPLET EVAPORATION”; the entire contents of each of which are incorporated by reference herein.

### TECHNICAL FIELD

The present invention generally relates to the dispensing of liquids onto a substrate, and particularly to liquid dispensing in a manner that reduces droplet evaporation during and after the dispensing. The liquid dispensing may be implemented, for example, as part of the fabrication of an array such as a chemical or biochemical array.

### BACKGROUND

A liquid dispensing (or deposition) device may be utilized to dispense one or more droplets onto one or more locations on a solid substrate such as a glass slide. A common example of a liquid dispensing device is a printer such as an inkjet printer. Depending on the application that requires the liquid dispensing, the droplets dispensed may be small, for example, on the order of microliters (μL), nanoliters (nL), or picoliters (pL) in volume. Once the dispensed droplets are deposited onto the substrate, the deposited droplets may be on the order of micrometers (μm) in size (e.g., diameter) or smaller. Some applications involve the dispensing of droplets as part of fabricating a DNA or RNA microarray on a substrate, in which case the droplets dispensed may be, for example, around on the order of picoliters (e.g., a few pL or tens of pL) in volume and the droplets deposited on the substrate may be (initially) around order of micrometers (e.g., a few μm or tens of μm) in diameter. At such small scales, the droplets dispensed may evaporate in a few minutes or even a few seconds after being emitted from the liquid dispensing device due to their exposure to the surrounding open environment. Evaporation of the droplets reduces their size until, ultimately, no liquid phase remains if the evaporation is allowed to continue. The rapid evaporation of the droplets is due to their large surface-to-volume ratio and vapor pressure. The rate of evaporation also depends on the composition of the droplets and the operating environment or conditions under which the droplets are dispensed (e.g., temperature, humidity, partial pressure of the dispensed liquid, etc.). For example, droplets including a solvent such as propylene carbonate (PC) may evaporate completely in a few minutes after being emitted from the liquid dispensing device. By comparison, droplets including water as the solvent may evaporate in the same environment much more quickly, as the vapor pressure of water is more than 500 times higher than PC.

For many applications involving the dispensing of droplets, an excessive rate of evaporation can adversely affect the applications and the results intended to be achieved. For example, in the case of creating DNA or RNA oligomers, an excessive rate of evaporation may cause undesirable reagent concentrations, precipitation, or other undesirable effects including a failure to complete the desired reaction. It is even possible that droplets dispensed from a liquid dispensing device may evaporate completely before the reaction is complete, which may correspond to a complete failure of the application being implemented such as microarray fabrication.

Therefore, there is a need for addressing the evaporation of droplets dispensed from a liquid dispensing device.

### SUMMARY

To address the foregoing needs, in whole or in part, and/or other needs that may have been observed by persons skilled in the art, the present disclosure provides methods, processes, systems, apparatus, instruments, and/or devices, as described by way of example in implementations set forth below.

According to an implementation, a method for dispensing droplets includes: providing a substrate comprising a top surface; positioning the substrate under a cover to form a chamber, wherein the chamber contains a head space defined between the top surface and the cover; and dispensing droplets through the head space and into contact with the top surface while the substrate is positioned in the chamber.

According to another implementation, a liquid dispensing system includes: a cover; a substrate holder configured to hold a substrate under the cover, wherein the cover and the substrate when positioned under the cover form a chamber; and a liquid dispensing device configured to dispense droplets through the chamber and into contact with the substrate while the substrate is positioned in the chamber.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a top plan view of an example of a microarray according to an implementation of the present disclosure.

FIG. 2 is an elevational view of an example of a chamber, with a microarray such as illustrated in FIG. 1 positioned therein, according to an implementation of the present disclosure.

FIG. 3 is a top plan view of an example of a substrate that may be part of a microarray such as illustrated in FIGS. 1 and 2, according to an implementation of the present disclosure.

FIG. 4 is a cross-sectional elevational view of a substrate positioned under a liquid dispensing device according to an implementation of the present disclosure.

FIG. 5 is a front elevation view of an example of a liquid dispensing system according to an implementation of the present disclosure.

FIG. 6 is a schematic view of a system controller that may be provided in a liquid dispensing system such as illustrated in FIG. 5, according to an implementation of the present disclosure.

FIG. 7 is a flow diagram illustrating an example of a method for dispensing droplets according to an implementation of the present disclosure.

FIG. 8 is an image showing water droplets on a glass surface of a virtual chamber according to an implementation of the present disclosure.

The illustrations in all of the drawing figures are considered to be schematic, unless specifically indicated otherwise.

### DETAILED DESCRIPTION

In this disclosure, all “implementations,” “aspects,” “examples,” and “embodiments” described are considered to be non-limiting and non-exclusive. Accordingly, the fact that a specific “implementation,” “aspect,” “example,” or “embodiment” is explicitly described herein does not exclude other “implementations,” “aspects,” “examples,” and “embodiments” from the scope of the present disclosure even if not explicitly described. In this disclosure, the terms “implementations,” “aspect,” “example,” and “embodiment” are used interchangeably, i.e., are considered to have interchangeable meanings.

In this disclosure, the term “substantially,” “approximately,” or “about,” when modifying a specified numerical value, may be taken to encompass a range of values that include +/−10% of such numerical value, unless specifically indicated otherwise.

In this disclosure, the term “liquid” encompasses a single liquid-phase composition or a mixture or blend of two or more liquid-phase compositions. Examples of a liquid include, but are not limited to, a solution, a suspension, a colloid, or an emulsion. A liquid may contain or carry solid particles (e.g., inorganic particulates, whole biological cells or lysed cell components, etc.) and/or gas or vapor bubbles.

In this disclosure, the term “(bio)chemical compound” encompasses chemical compounds and biological compounds (or biomolecules). A chemical compound may be, for example, a small molecule or a high molecular-weight molecule (e.g., a polymer, carbohydrate, sugar, etc.). A biological compound may be, for example, a biopolymer. Examples include, but are not limited to, nucleic acids (or polynucleotides), such as deoxyribonucleotides, ribonucleotides, oligonucleotides (or “oligos”), proteins, and analogs or derivatives of the foregoing.

In this disclosure, the term “interaction” generally refers to an interaction between two or more components, where the components taking part in the interaction may be one or more elements, one or more molecules, or a combination of one or more elements and one or more molecules. The term “interaction” encompasses (bio)chemical reactions, including (bio)chemical synthesis.

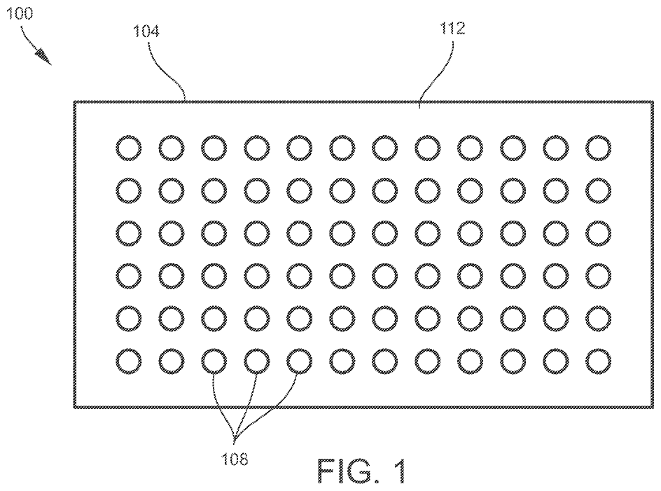

FIG. 1 is a top plan view of an example of an array (or microarray) 100 that may be fabricated by devices, systems and methods described in the present disclosure. The microarray 100 may be configured for various applications in fields such as, for example, immunoassays, genomics, proteomics, cell analysis, disease diagnosis or other disease analysis or prediction, drug discovery, combinatorial chemistry, etc. The microarray 100 includes a solid substrate 104, and a one-dimensional (1D) or (more typically) two-dimensional (2D) array of spots 108 (or features, or liquid deposition sites, or “virtual wells,” etc.) disposed on a top surface (or substrate surface) 112 of the substrate 104. The spots 108 correspond to discrete, individually identifiable locations on the top surface 112. Moreover, the spots 108 may be individually addressable (e.g., assignable to individual (X-Y) coordinates), discernable and locatable by appropriate instrumentation such as a camera or other type of sensor.

The substrate 104 is configured as a solid support for droplet deposition, which may be part of microarray fabrication as noted above. That is, the substrate 104 (or at least its top surface 112) may be composed of any solid material suitable for serving as a solid support for the (bio)chemical interactions carried out at the sites of the liquid spots 108, which interactions are application-dependent. As one example, the (bio)chemical interactions may be part of deoxyribonucleic acid (DNA) or ribonucleic acid (RNA) synthesis. Examples of the material of the substrate 104 include, but are not limited to, various glasses, quartz or fused silica, polymer-coated glasses, polymers (e.g., poly(methyl methacrylate) or PMMA, polydimethylsiloxane or PDMS, SU-8, etc.), ceramics, and silicon. The top surface 112 of the substrate 104 may be derivatized/functionalized/modified as needed for a particular application, as appreciated by persons skilled in the art. For example, the substrate 104 may be pretreated to render the top surface 112 hydrophobic and thereby optimize the formation of uniform or homogeneous spots 108. In other words, after dispensed droplets contact designated spots 108 on the top surface 112, the droplets may be uniformly sized and maintain a substantially hemispherical or dome shape. Silanized glass is one example of a pretreated substrate 104. As another example, a substrate 104 may be pretreated in the sense that spots 108 are initially formed with a starting material (e.g., a biochemical probe, a pad configured to facilitate oligonucleotide extension, etc.) prior to implementation of any of the liquid dispensing methods disclosed herein.

The substrate 104 in FIG. 1 is typically (but not necessarily) planar or plate-shaped, meaning that the thickness (in the direction of the drawing sheet) of the substrate 104 is the smallest physical dimension in comparison to the length and width of the substrate 104 in the horizontal plane shown. As such, in various implementations, the substrate may be characterized as plate, slide, chip, etc. The substrate 104 is typically (but not necessarily) rectilinear, as shown in FIG. 1.

In the present example, the top surface 112 of the substrate 104 is a flat, continuous surface and the spots 108 define virtual wells as opposed to actual, structurally distinct wells formed in the substrate 104. In other implementations, however, the substrate 104 may include depressions or actual wells (e.g., like a microplate) that serve as individually addressable sites for receiving dispensed droplets. In other words, the spots 108 may be located in actual wells of the substrate 104. Alternatively, the spots 108 may define raised features that serve as individually addressable sites for receiving dispensed droplets.

The composition of the spots 108 depends on the application being implemented and the current stage or step of the application being implemented. For example, prior to performing a given step of droplet deposition onto the spots 108, the spots 108 may be “empty” locations on the top surface 112, i.e., not containing any material. As another example, prior to performing a given step of droplet deposition onto the spots 108, the spots 108 may contain functional groups and/or one or more partially or wholly dried materials. After performing a given step of droplet deposition onto the spots 108 (or onto a selected subset of spots 108 of the overall array of spots 108), the spots 108 contain the droplets (i.e., the material that is part of the droplets that were dispensed). At a given instance of time, the droplet material on the spots 108 may be partially or wholly dried depending on the degree of evaporation that has occurred. At a given instance of time, the spots 108 may contain the product of one or more (bio)chemical interactions that have been carried out during the process of microarray fabrication. For example, in the case of DNA or RNA microarray fabrication, the spots 108 may be or include DNA or RNA probes immobilized on the top surface 112 of the substrate 104, and target molecules bound to the DNA or RNA probes. Protein-based arrays may also be fabricated by application of the subject matter disclosed herein, such as for analyzing protein-protein or protein-ligand interactions. As another example, the spots 108 may be or include the results of non-biological chemical reactions, synthesis, or other type of interaction between chemical compounds. More generally, the composition of the spots 108 may vary during a liquid dispensing or array fabrication process. For example, the composition of the spots 108 may differ at different, intermediate stages of an array fabrication process. Depending on the stage of an array fabrication process, the spots 108 may or may not be dry at the time a particular droplet dispensing step is performed.

The number of rows and columns of spots 108 and the total number of spots 108 shown in FIG. 1 is merely illustrative. The number of spots 108 may range from a few (e.g., 10) to one hundred or a few hundred (e.g., for diagnostic applications), or to hundreds of thousands or several million (e.g., for high-throughput research or screening applications). The spacing between adjacent spots 108 is typically uniform throughout the array although this is not a requirement. The spacing between adjacent spots 108 is typically large enough to avoid cross-contamination between adjacent spots 108 or merging of adjacent spots 108, and to enable the spots 108 to be spatially discrete and individually identifiable (e.g., individually addressable by detection/imaging technology). As examples, the volume of a droplet deposited on the substrate 104 may be on the order of picoliters (pL) (e.g., in a range from 1 or a few pL to 1000 pL) or nanoliters (nL) (e.g., in a range from 1 or a few nL to 1000 nL), the diameter of a spot 108 on the substrate 104 after receiving a droplet and the spacing between adjacent spots 108 may be on the order of micrometers (μl) (e.g., in a range from 1 or a few μm to 1000 μm), and the density of the spots 108 in the microarray 100 may be on the order of a few thousand, tens of thousands, or several hundred thousands of spots 108 per square centimeter (cm²). The constructed microarray 100 may be used as a means to fabricate individual or libraries of molecules which may be subsequently used as a microarray or wholly or partially cleaved from the surface 112.

Examples of microarray fabrication are described in, for example, U.S. Patent App. Pub. No. 2008/0206850; U.S. Pat. No. 8,778,849; Lausted et al., POSaM: a fast, flexible, open-source, inkjet oligonucleotide synthesizer and microarrayer, Genome Biology, Vol. 5, Issue 8, Article R58 (2004); Dufva, Fabrication of high quality microarrays, Biomolecular Engineering (2005); and Barbulovic-Nad et al., Bio-Microarray Fabrication—A Review, Critical Reviews in Biotechnology, 26:237-259 (2006); the entire contents of each of the foregoing being incorporated by reference herein.

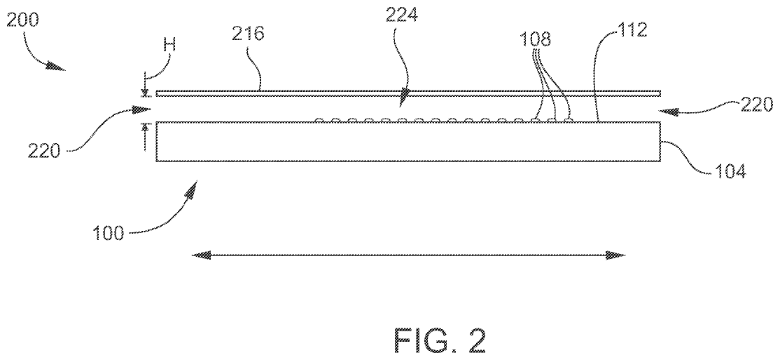

FIG. 2 is an elevational view of an example of a chamber 200 according to an aspect of the present disclosure, with a microarray 100 (fully or partially fabricated) such as illustrated in FIG. 1 positioned in the chamber 200. The chamber 200 may be a partially open (or partially closed, or “virtual”) chamber in the sense that it need not be entirely enclosed or sealed on all sides/edges relative to the operating environment surrounding the chamber 200. As illustrated, the chamber 200 may be defined or bounded at least in part by the top surface 112 of the substrate 104 and a cover or lid 216 positioned above the substrate 104. By this configuration, one or more sides or edges of the chamber 200, for example lateral sides or edges 220, may be open to the surrounding environment. The interior of the chamber 200 may be considered to be a (partially open/partially closed) head space 224, which is defined at least in part by a vertical distance or gap, or head space height H, between the top surface 112 of the substrate 104 and the cover 216. The head space height H may be minimized to create a small, partially enclosed volume in which the spots 108 reside. With this small, partially enclosed volume, as the droplets evaporate, the evaporation rate of the droplets quickly comes to equilibrium with the condensation rate. When this equilibrium state is reached, the droplets no longer change size, because just as many molecules of the dispensed droplets enter the liquid phase state from the gas phase as molecules leave the droplets. Inside the chamber 200, at some instance of time, the head space 224 contains gas-phase or vapor-phase species in equilibrium with the vapor pressure of the surfaces of the deposited droplets (spots 108).

In the configuration illustrated in FIG. 2, the chamber 200 (or head space 224) is only partially enclosed, but nonetheless provides a confined environment around the spots 108 that reduces the rate of evaporation of evaporable liquids residing in the head space 224. Over time, the dispensed droplets eventually will evaporate completely. However, the chamber 200 is configured to slow down the process of evaporation (i.e., lower the evaporation rate) sufficiently enough to allow for the droplets to be processed (e.g., to undergo an intended interaction such as a (bio)chemical reaction) in accordance with the application being implemented. In other words, when a droplet is dispensed from a liquid dispensing device onto the substrate 104, an evaporation period of time begins (dependent on material composition and operating conditions, as noted above) and also an application-dependent interaction period of time begins (e.g., an interaction occurring at the spot 108 where the droplet was deposited). The chamber 200 is configured such that the duration of the interaction period is shorter than the duration of the evaporation period (or, equivalently, the duration of the evaporation period is longer than the duration of the interaction period). For many applications, the duration of the interaction period will be much shorter than the duration of the evaporation period, which minimizes the amount of shrinkage of the droplets due to evaporation (and accordingly minimizes the amount of solvent or evaporable material leaving the droplet). Partial evaporation of the solvent or evaporable material within the droplet may change the concentration of the solutes within the dispensed material, which can impact the desired surface reaction. For example, partial evaporation may cause solutes to exceed their solubility limit and precipitate onto the top surface 112. The size of the head space 224, particularly the head space height H, may be adjusted as needed for a given application, in particular to adjust the total volume enclosed (or partially enclosed by the head space 224. The smaller the head space 224, the quicker the droplets will reach equilibrium and the less the droplets will shrink. Generally, the magnitude of the head space height H depends on the application and operating parameters such as the vapor pressure of the liquid, the total volume of the liquid available as a vapor source, etc. For many applications, the head space height H may be on the order of micrometers (i.e., between one or a few μm to 1000 μm). As examples, the head space height H may be 1000 μm or less, or in a range from 350 μm to 400 μm. In some implementations, the substrate 104 and/or the cover 216 may be moved in the vertical (e.g., Z) direction to adjust the head space height H.

The substrate 104 may be movable relative to the cover 216 along one or more axes. A double arrow in FIG. 2 represents movability of the substrate 104 along one horizontal axis (e.g., X-axis or Y-axis). Movement of the substrate 104 from an external position outside the space where the chamber 200 is formed to an internal (or operating) position directly under the cover 216, as shown in FIG. 2, forms the chamber 200. As examples, from the perspective of FIG. 2, the substrate 104 may be moved (e.g., linearly translated) from the left or right toward the chamber 200 to be formed, and/or from the front or the back (i.e., in a direction into or out from the plane of the drawing sheet) toward the chamber 200 to be formed. In the present implementation, the open lateral sides 220 of the chamber 200 facilitate the movement of the substrate 104, for example by eliminating a need for opening and closing/sealing the chamber 200 one or more times during the performance of a method utilizing the substrate 104.

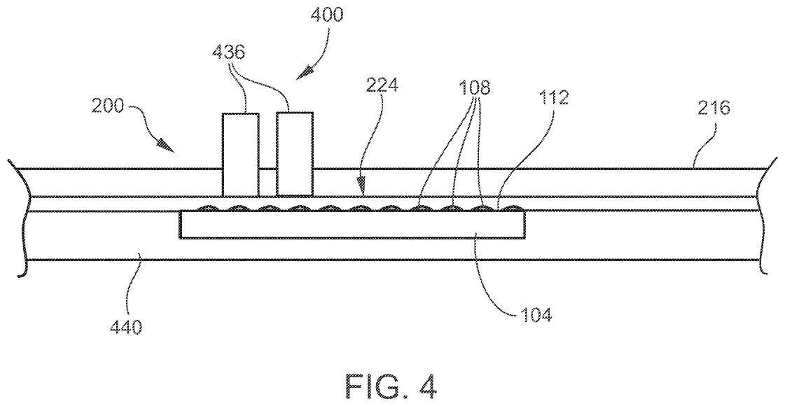

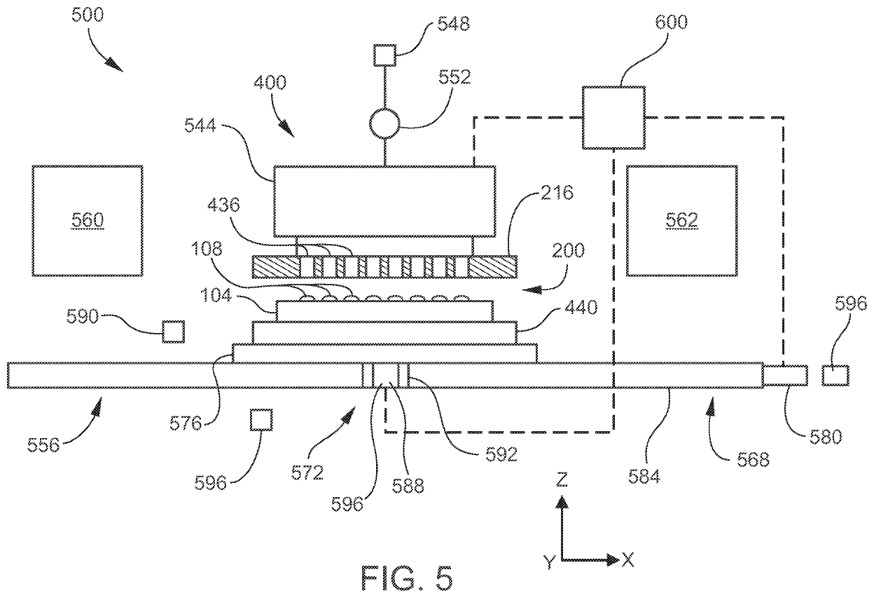

In various implementations, at the internal or operating position, the substrate 104 is correctly aligned with dispensing elements (e.g., outlets, nozzles, etc.) of a liquid dispensing device (e.g., the liquid dispensing device 400 and dispensing elements 436 described below in conjunction with FIGS. 4 and 5) to enable droplets to be dispensed onto the intended addresses or spots 108 on the top surface 112 of the substrate 104. Depending on the application, various tasks may be performed while the substrate 104 is positioned outside the chamber 200, for example, at other operating stations of an associated system. For example, the substrate 104 may be mounted to an appropriate substrate holder that moves the substrate 104 to different stations. The substrate 104 (particularly the top surface 112) also may be prepared as needed for the subsequent dispensing operations carried out at the chamber 200. As a few examples, the substrate 104 may be heated, the top surface 112 may be functionalized (e.g., to render the top surface 112 or designated spot sites on the top surface hydrophobic or more hydrophobic, or to attach materials configured to enhance the formation of droplet-containing spots 108, etc.), starting materials (e.g., (bio)chemical compounds, ligands, etc.) may be attached to the top surface 112 for subsequent contact with droplets, etc. The substrate also may be washed or contacted by reagents or other solutions prior to and/or after any particular droplet dispensing operation, and/or between multiple iterations of dispensing operations. As another example, after one or more droplet dispensing operations have been carried out, the spots 108 containing material from the droplets may be measured, analyzed, or imaged by an appropriate instrument while the substrate 104 is positioned outside the chamber 200. Alternatively, the spots 108 may be measured, analyzed or imaged within the chamber 200. For example, the substrate 104 may be moved away from liquid dispensing elements that dispense droplets into the chamber 200 to an analysis region that is under the cover 216 and in operative alignment with an instrument configured for performing measurement/detection, analysis, image capture, etc.

In the example illustrated in FIG. 2, a single substrate 104 is shown. However, more than one substrate 104 may be provided in the chamber 200, or more than one distinct chamber 200 formed by one or more substrates 104 may be provided.

Generally, no limitation is placed on the composition of the material constituting the cover 216. In some implementations, the cover 216 or a region of the cover 216 (e.g., a window) is made of a transparent material to enable the droplets and array of spots 108 to be observed, optionally with the aid of a camera or the like, and/or analyzed or imaged as noted above.

In an alternative implementation, the interior volume or head space 224 may be fully enclosed or sealed on all sides (e.g., including the lateral sides 220), by providing a fully enclosable chamber instead of the partially open chamber 200 described above. Whether a fully enclosable chamber is needed or not is an application-dependent consideration.

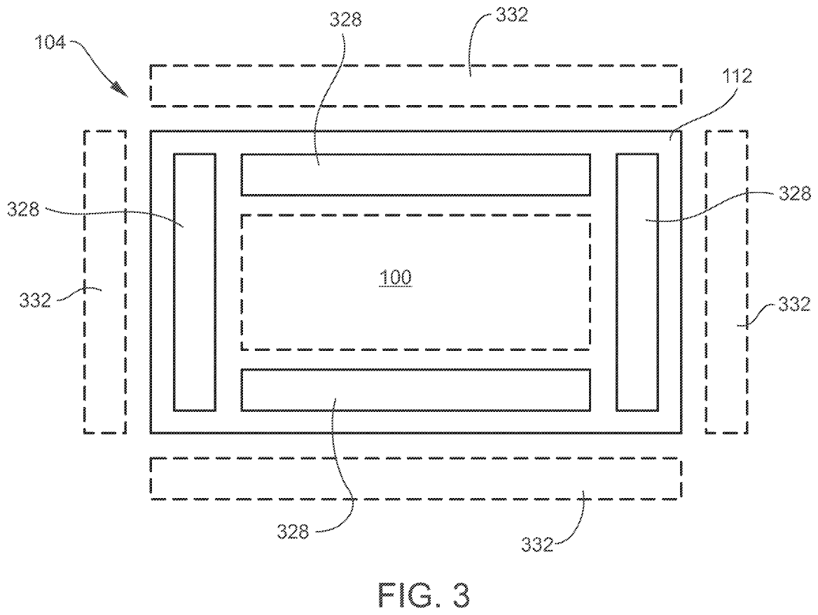

FIG. 3 is a top plan view of another example of the substrate 104. In this example, the substrate 104 includes one or more wells 328 (or other type of containers) for containing a “sacrificial” liquid. In the present context, a “sacrificial” liquid is one that readily evaporates in the operating environment and is the same liquid (has the sample composition) as the evaporable material of the droplets deposited (e.g., solvent, buffer, etc.) onto the spots 108 (FIG. 2). By saturating the operating environment with vapor sourced from the sacrificial liquid, the evaporation rate of the droplets may be reduced, thereby extending the evaporation period. Moreover, the vapor added by providing the sacrificial liquid replenishes any vapor that may have been lost through any open portions of the chamber 200 (e.g., the open lateral sides/edges 220 shown in FIG. 2). The wells 328 serve as reservoirs for the sacrificial liquid and hence as sources of the added vapor.

In an implementation, the sacrificial liquid may be contained in or by one or more bodies of an appropriate porous material. As an example, the porous material may be substituted for open wells such as the wells 328 described above in conjunction with FIG. 3. Additionally or alternatively, the porous material may serve as a cover or lid for an underlying well 328. Hence, depending on the implementation and the composition of the porous material, the sacrificial liquid as initially provided may be retained (or contained) in the pores of the porous material, and/or at least partially adsorbed to the surfaces of the porous material (e.g., in the pores), and/or at least partially absorbed in the porous material before evaporating, and/or pass through the porous material while evaporating (such as from underlying wells 328).

At a certain stage of a method, the spots 108 may include two or more different types of evaporable liquids, due to the droplets deposited containing multiple evaporable components or due to multiple droplets containing different evaporable components having been deposited on the same spots 108. In such cases, the sacrificial liquid may be composed of the same plurality of different evaporable materials that are part of the deposited droplets.

The wells 328 may be referred to as “substrate” wells in the sense that they are formed on/in the top surface 112 of the substrate 104, or are containers disposed on the top surface 112. Alternately or additionally, “outboard” wells 332 (indicated by dashed lines) may be provided and positioned outside and adjacent to the peripheral sides of the substrate 104. The outboard wells 332 may, for example, be part of a structure on which the substrate 104 is supported or mounted (e.g., a substrate holder 440 such as described below in conjunction with FIGS. 4 and 5). Depending on the implementation, such structure may be part of the chamber 200, the liquid dispensing device, or an associated larger system in which the chamber 200 and liquid dispensing device operate.

In an implementation, the area of the chamber 200 (or the planar footprint of the chamber 200 in the horizontal plane) may extend beyond the physical boundaries of the substrate 104, as shown in FIG. 4 in comparison to FIG. 2. For example, the horizontal area spanned by the cover 216 may extend beyond the substrate 104 and thus cover other underlying structures such as a substrate holder. In such implementations, the outboard wells 332, although outside the substrate 104, may nonetheless be positioned inside the chamber 200 as opposed to outside the chamber 200.

Generally, the well(s) 328 and/or wells 332 may have any configuration (e.g., shape, dimensions, locations, etc.) effective to provide a volume of sacrificial liquid for saturating the operating environment. In the illustrated example, four rectilinear wells 328 are positioned at or near the periphery of the top surface 112 of the substrate 104, such that the wells 328 surround a central section of the substrate 104 (indicated by dashed lines) where the microarray 100 is to be fabricated. More or less than four wells 328 may be utilized. Moreover, instead of multiple, discrete wells 328 separated from each other, a single well 328 may surround the area of the microarray 100 (in the plane of the top surface 112) in a continuous/contiguous manner. Alternatively or additionally, multiple (e.g., four) rectilinear wells 332 are positioned at or near (and adjacent to) the substrate 104. Alternatively, a single well 332 may surround the substrate 104 in a continuous/contiguous manner.

In the implementations just described, by utilizing the wells 328 and/or 332, the sacrificial liquid is provided separately from the droplets dispensed that contain one or more materials participating in interactions at the spots 108. Alternatively or additionally, droplets comprising only the sacrificial liquid (e.g., without chemical precursors, reactants, or the like) also may be deposited or ink-jetted around the periphery of the microarray 100, and/or within the microarray 100 (e.g., within an array of spots 108), and/or outside and adjacent to the substrate 104 (e.g., at or near the locations shown in FIG. 3 where the wells 332 may or may not be located). One or more printheads 544 or liquid dispensing elements 436 of the liquid dispensing device 400 (see FIGS. 4 and 5) may be utilized to deposit the sacrificial liquid as droplets, which are separate from droplets dispensed that contain one or more materials participating in interactions at the spots 108. Alternatively or additionally, the liquid dispensing device 400 may be configured to fill wells 328 and/or 332 by dispensing sacrificial liquid, as discrete droplets or continuous streams of liquid.

Some methods utilizing the chamber 200 may carry out a pre-saturation period of time during which the sacrificial liquid (sourced from wells and/or dispensed liquid) is allowed to evaporate for a desired period of time before dispensing the droplets.

FIG. 4 is a cross-sectional elevational view of a substrate 104 positioned under a liquid dispensing device 400, in particular under dispensing elements 436 of the liquid dispensing device 400. The substrate 104 is mounted to an appropriate substrate holder 440. The substrate holder 440 may be configured to be movable such that the substrate 104 is movable with the substrate holder 440 toward and away from the space where the chamber 200 is formed under the cover 216 and the dispensing elements 436.

The substrate holder 440 is configured to hold the substrate 104 (or more than one substrate 104) in a secure and repeatable position on or in the substrate holder 440. For this purpose, the substrate holder 440 may include appropriate mechanical mounting features (e.g., clamps, pins, adhesive, etc.). Alternatively or additionally, the substrate holder 440 may be or include a vacuum chuck configured to hold the substrate 104 by application of a vacuum at the underside of the substrate 104. In the latter case, the substrate holder 440 communicates with a suitable vacuum source such as a vacuum pump of any suitable type (not shown).

Generally, no limitation is placed on the type of liquid dispensing device 400 provided, or the type of liquids dispensed by the liquid dispensing device 400. At present, it is contemplated that the liquid dispensing device 400 is a non-contacting device, i.e., the dispensing elements 436 do not contact the top surface 112 of the substrate 104 when dispensing droplets. Examples of non-contacting dispensing elements 436 include, but are not limited to, simple orifices and nozzles. In some implementations, the liquid dispensing device 400 is configured as a multi-channel printer (module or assembly), where the “ink” printed (or “written”) is the droplet material described herein. Thus, the dispensing elements 436 of the non-contacting, printer-type liquid dispensing device 400 may be inkjet or bubble-jet nozzles, which may dispense droplets according to mechanisms now known or later developed, such as pressure-based, thermal-based, or piezoelectric-based actuation, as appreciated by persons skilled in the art. In other implementations, liquid dispensing device 400 may be configured for contact printing, in which case the dispensing elements 436 may be solid pins, slotted pins, micro-stamps, etc. as appreciated by persons skilled in the art. In an implementation, the liquid dispensing device 400 is configured for use in a technique, now known or later developed, which is based on phosphoramidite chemistry. Thus, one example of a liquid printed by the printer 344 is a solution containing one or more types of nucleoside phosphoramidites. In another implementation, the liquid dispensing device 400 is configured for use in a technique, now known or later developed, which is based on enzymatic DNA or RNA synthesis. Thus, an example of a liquid printed by the printer 344 is a solution containing one or more types of nucleotides or a solution containing an enzyme.

In an implementation, the dispensing elements 436 are arranged in a 1D or 2D array having a size (total number of dispensing elements 436, and number of rows and columns of dispensing elements 436) and an element-to-element spacing that matches the size and spacing of the spots 108 on the substrate 104 at which printing occurs. In an application that does not require all droplets to be printed on the entire array of spot sites simultaneously, the array of dispensing elements 436 may be smaller than the array of spot sites. In this latter case, the substrate holder 440 may be configured to be moved along one or more axes, and multiple printing jobs may be executed, until the entire array has been printed on the substrate 104.

In the present example, the dispensing elements 436 extend into holes formed in the cover 216 and thereby into fluid communication with the head space 224 defined by the chamber 200. In this configuration, it may be advantageous for the dispensing elements 436 and the cover 216 to be stationary components, with only the substrate 104/substrate holder 440 being movable.

FIG. 5 is a front elevation view of an example of a liquid dispensing system 500 in which the substrate (or substrates) 104, chamber (or chambers) 200, and liquid dispensing device 400 may operate. For purposes of description, FIG. 5 includes an arbitrarily located Cartesian coordinate (X-Y-Z) frame of reference.

In the illustrated example, the liquid dispensing device 400 is configured as a printer that includes one or more printheads 544 each supporting an array of dispensing (printing or writing) elements 436 as described above in conjunction with FIG. 4. The liquid dispensing system 500 may include one or more liquid reservoirs 548 containing respective liquids to be dispensed ((bio)chemical precursors, reagents, sacrificial liquid, etc.), and one or more liquid flow devices 552 (e.g., pumps) configured to establish flows of liquid from the liquid reservoirs 548 to the dispensing elements 436. The liquid reservoir(s) 548 and the liquid flow device(s) 552 may or may not be integrated with the printhead(s) 544, depending on the implementation.

The liquid dispensing system 500 also may include a staging assembly (or motion control system) 556 configured to move (transport) the substrate holder 440, and thus the substrate 104 supported thereon, along one or more axes. In particular, the staging assembly 556 is configured to move the substrate 104 to the above-described internal or operating position that establishes the chamber 200 and places the substrate 104 in proper alignment with the dispensing elements 436 in preparation for intended dispensing operations. The staging assembly 556 may also be configured to move the substrate holder 440 and substrate 104 to one or more other positions, such as other stations (e.g., stations 560 and 562 shown in FIG. 5) of the liquid dispensing system 500. Such other stations 560 and 562 may be configured for further processing of the substrate 104 as described elsewhere herein. For example, the station 560 or 562 may include a flow cell configured to flow one or more types of a bulk liquid into contact with the top surface 112 of the substrate 104 and in particular with the spots 108 on the substrate 104, as appreciated by persons skilled in the art. Examples of bulk liquids that may be flowed into the flow cell include, but are not limited to, solutions configured to carry out hybridization of probes already immobilized at the spots 108 on the substrate 104, solutions configured to remove non-specifically bound target molecules from the substrate 104, various reagents such as deprotection reagents, capping reagents and oxidizer reagents, solvents, linkers, catalysts, buffers, solutions for washing/rinsing, etc.

In the present example, the staging assembly 556 includes an X-axis (or first axis) drive assembly 568, a Y-axis (or second axis) drive assembly 572, and a movable stage 576. The X-axis drive assembly 568 is configured to move the substrate holder 440 and substrate 104 back and forth along the X-axis, in particular to and from the liquid dispensing device 400 and chamber (or chambers) 200. The Y-axis drive assembly 572 is configured to move the substrate holder 440 and substrate 104 back and forth along the Y-axis, which may be useful for various functions. For example, the Y-axis drive assembly 572 along with the X-axis drive assembly 568 may be utilized to accurately and repeatedly position the substrate 104 in the correct location in the X-Y plane relative to the dispensing elements 436 of the liquid dispensing device 400. As another example, either the Y-axis drive assembly 572 or the X-stage drive assembly 568 may be useful for facilitating the loading of the substrate(s) 104 onto the substrate holder 440 and/or the removal of the substrate(s) 104 from the substrate holder 440. The staging assembly 556 may also include a Z-axis (or third axis) drive assembly (not shown) if needed to adjust the vertical position of the substrate 104 relative to the dispensing elements 436 and/or the cover 216, and/or relative to other instruments or devices of the liquid dispensing system 500.

The X-axis drive assembly 568 includes an X-axis driver 580 (including, for example, a bidirectional stepper motor or servo motor) configured to drive movement of a linear guide and transmission linkage 584 (e.g., belt and pulley, chain and cog, screw and worm gear, etc.). Similarly, the Y-axis drive assembly 572 includes a Y-axis driver 588 (including, for example, a bidirectional stepper motor or servo motor) configured to drive movement of a linear guide and transmission linkage 592 (e.g., belt and pulley, chain and cog, screw and worm gear, etc.). In the illustrated example, the substrate 104 (or the substrate 104 as attached to the substrate holder 440 and, in turn, the movable stage 576) is coupled directly to the Y-axis drive assembly 572, which is in turn coupled to the X-axis drive assembly 568. Alternately, the substrate 104 may be coupled via the movable stage 576 directly to the X-axis drive assembly 568, which in turn is coupled to the Y-axis drive assembly 572. More generally, persons skilled in the art will appreciate that various other configurations for the staging assembly 556 as a motion control system may be implemented to realize controlled motion of the substrate 104 along the desired axis or axes.

The substrate holder 440 may optionally include temperature control means to raise or lower the temperature of the substrate 104 (e.g., electrically resistive/Joule/ohmic heating devices, thermoelectric or Peltier heating or cooling devices, fans, devices for circulating a heat transfer medium, etc.), as appreciated by persons skilled in the art.

The order or sequence of the movements of the substrate 104 performed by the liquid dispensing system 500 (in particular the staging assembly 556), and the number of times (iterations) that one or more of these movements are repeated or cycled during a given operation or procedure, depend on the particular application or method being implemented. In applications requiring multiple iterations of droplet dispensing, the staging assembly 556 may be configured to position the substrate 104 under the dispensing elements 436 in an accurate and highly repeatable manner, in particular to achieve high droplet-on-droplet (or droplet-on-spot) accuracy when droplets are to be dispensed on spots 108 at which other droplets were previously dispensed (i.e., at the same spot sites).

To enhance positional accuracy and repeatability, the liquid dispensing system 500 also may include one or more positional sensors (e.g., encoders) 596 configured to measure and track the position of the movable stage 576 (or substrate 104, or other devices or instruments), including to assist in properly aligning the substrate 104 with the dispensing elements 436 of the liquid dispensing device 400. A few examples of possible locations of such positional sensors 596 are schematically illustrated in FIG. 5. The use of positional sensors 596 in cooperation with movable components of a system such as the illustrated liquid dispensing system 500 are generally understood by persons skilled in the art. Such positional sensors 596 may be utilized, for example, to measure the position of the substrate 104 with reference to a coordinate system (e.g., considering one or more X-, Y-, Z-, θ-axes), determine whether the substrate position has changed (deviated) in comparison to the previous iteration of the same operational step, calibrate a component responsible for moving or adjusting the substrate position, etc. Generally, positional sensors are appreciated by persons skilled in the art, and often are optics-based devices. For example, a positional sensor 596 may include a light source (e.g., a laser, laser diode (LD), light-emitting diode (LED), broadband lamp, etc.) and a light detector (e.g., a photodiode (PD), photomultiplier tube (PMT), camera, etc.), or additionally other optical components, (e.g., a lens, mirror, etc.). Optionally, one or more positional sensors 596 may detect features on the substrate 104 such as fiducials, features on the substrate holder 440, or encoder positions. In addition, one or more positional sensors 596 may be positioned to direct a light beam into intersection with the paths of droplets dispensed by the printing elements 436, thus enabling the detection of misfiring by one or more of the printing elements 436 (e.g., due to clogging or hardware/circuitry malfunction).

The liquid dispensing system 500 also may include a system controller (or controller, or computing device) 600. The system controller 600 may schematically represent one or more modules (or units, or components) configured for controlling, monitoring and/or timing various functional aspects of the liquid dispensing system 500 including, for example, the operations of the liquid dispensing device 400, the staging assembly 556, and other instruments or devices located at various stations (e.g., 560 and 562). For all such purposes, the system controller 600 may be in wired or wireless communication with one or more components of the liquid dispensing system 500, as depicted by dashed lines in FIG. 5, and may include any suitable combination of hardware, firmware, software, etc., including one or more electronics-based processors and memories, as appreciated by persons skilled in the art. For example, the system controller 600 may include a non-transitory (or tangible) computer-readable medium that includes non-transitory instructions for performing any of the methods disclosed herein.

The liquid dispensing system 500 also may include a deck (or table, bench, optical bench, platform, base, etc., not shown) on which various components of the liquid dispensing system 500 described above are supported. Such components may be fixed or attached to the deck or may simply rest on the deck. The deck may be configured to suppress vibrations generated by certain components of the liquid dispensing system 500. Depending on the implementation, the deck may be considered to be part of or separate from the liquid dispensing system 500. In addition, all or part of the liquid dispensing system 500 may be enclosed by an appropriate enclosure, which may be transparent and/or gas-tight to maintain a controlled (e.g., humid, dry etc.) operating environment. The liquid dispensing system 500 may include a system for introducing gas or vapor to create the desired operating environment in the enclosed interior space if needed for a given application.

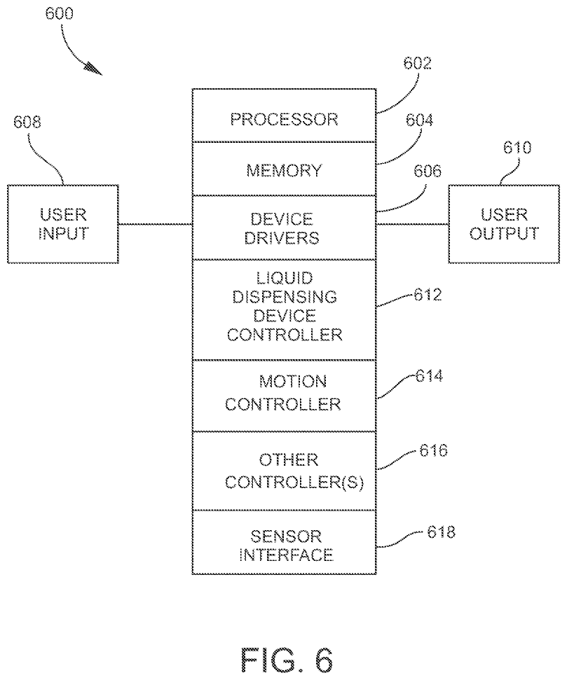

FIG. 6 is a schematic view of the above-noted system controller (or controller, or computing device) 600 that may be provided in the liquid dispensing system 500 according to an implementation of the present disclosure. The controller 600 may schematically represent one or more modules, control units, components, or the like configured for controlling, monitoring, analyzing and/or timing the operations of various devices or components of the liquid dispensing system 500, as well as controlling or executing one or more steps of any of the methods disclosed herein. In addition to the various controllable devices or components described above in conjunction with FIGS. 1-5, other devices may include, but are not limited to, electrical power (voltage) sources, timing controllers, clocks, frequency/waveform generators, processors, logic circuits, memories, databases, etc. One or more modules of the controller 600 may be, or be embodied in, one or more devices located outside or separate from the liquid dispensing system 500. Thus, one or more modules of the controller 600 may be, or be part of, a computer workstation, desktop computer, laptop computer, portable computer, tablet computer, handheld computer, mobile computing device, personal digital assistant (PDA), smartphone, etc. One or more modules of the controller 700 may communicate with one or more other modules via one or more busses or other types of communication lines or wireless links (e.g., an appropriate communication network), as appreciated by persons skilled in the art.

In the illustrated implementation, the controller 600 includes one or more electronics-based processors 602, which may be representative of a main electronic processor providing overall control, and one or more electronic processors configured for dedicated control operations or specific signal processing tasks (e.g., a graphics processing unit or GPU, a digital signal processor or DSP, an application-specific integrated circuit or ASIC, a field-programmable gate array or FPGA, etc.). The controller 600 also includes one or more memories 604 (volatile and/or non-volatile types, e.g. RAM and/or ROM) for storing data and/or software. Stored data may be organized, for example, in one or more databases or look-up tables. The controller 600 may also include one or more device drivers 606 for controlling one or more types of user interface devices and providing an interface between the user interface devices and components of the controller 600 communicating with the user interface devices. Such user interface devices may include user input devices 608 (e.g., keyboard, keypad, touch screen, mouse, joystick, trackball, and the like) and user output devices 610 (e.g., display screen, printer, visual indicators or alerts, audible indicators or alerts, and the like). In various implementations, the controller 600 may be considered as including one or more of the user input devices 608 and/or user output devices 610, or at least as communicating with them.

In some implementations, the controller 600 may also include one or more types of computer programs or software contained in memory 604 and/or on one or more types of non-transitory (or tangible) computer-readable media. One or more devices of the controller 600 may be configured to receive and read (and optionally write to) the computer-readable media. The computer programs or software may contain non-transitory instructions (e.g., logic instructions) for controlling or performing various operations of the liquid dispensing system 500, such as the operations of the various devices described herein. The computer programs or software may include system software and application software. System software may include an operating system (e.g., a Microsoft Windows® operating system) for controlling and managing various functions of the controller 600, including interaction between hardware and application software. In particular, the operating system may provide a graphical user interface (GUI) displayable via a user output device 610, and with which a user may interact with the use of a user input device 608. Application software may include software configured to control or execute various operations of the liquid dispensing system 500, and/or some or all of the steps of any of the methods disclosed herein.

The controller 600 may also include a liquid dispensing device (e.g., printer) controller (or control module) 612 configured to control the operation of the liquid dispensing device 400 (FIGS. 4 and 5), a motion or stage controller (or control module) 614 configured to control the operation of the staging assembly 556 (FIG. 5), and one or more other controllers 616 configured to control the operation of instruments and devices located at one or more stations 560 and 562 (FIG. 5) such as described above. The controller 600 may also include one or more sensor interfaces 616 configured to receive and process feedback (e.g., measurement) signals received from one or more sensors provided with the liquid dispensing system 500, such as the positional sensors 590 described above (FIG. 5), temperature sensors, pressure sensors, humidity sensors, etc. For example, the sensor interfaces 616 may be embodied in different pieces of firmware or other electronic circuitry that are part of a microcontroller of the controller 600. The sensor interfaces 616 may communicate with the liquid dispensing device controller 612, the motion controller 614, and the other controller(s) 616 as needed to provide effective control of various operations of the liquid dispensing system 500 described herein. The firmware or other electronic circuitry embodying the liquid dispensing device controller 612, the motion controller 614, and the other controller(s) 616 also may be provided with the same microcontroller that includes the sensor interfaces 616, or may be provided with separate hardware of the controller 600.

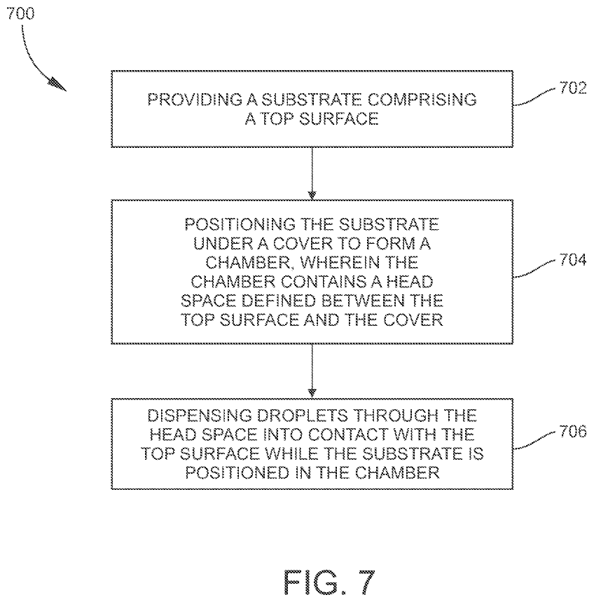

FIG. 7 is a flow diagram 700 illustrating an example of a method for dispensing droplets according to an implementation of the present disclosure. The method may utilize, for example, one or more of the components described above in conjunction with FIGS. 1-6. In the method, a substrate is provided (step 702). The substrate is positioned under a cover to form a chamber such that the chamber contains a head space defined between a top surface of the substrate and the cover (step 704). Before positioning the substrate 104, the substrate 104 may be prepared for droplet dispensing operations in accordance with the specific application being implemented. Droplets are dispensed through the head space into contact with the top surface of the substrate while the substrate is positioned in the chamber (step 706).

In an implementation, the droplets are dispensed from a liquid dispensing device that includes dispensing elements extending into the cover and into fluid communication with the head space. The liquid dispensing device may be, for example, a printer.

In an implementation, the chamber is partially open to an environment surrounding the chamber.

In an implementation, a height of the head space is set (or adjusted), and thus a volume of the head space is set (or adjusted), to set a rate of evaporation of the droplets in the head space, in particular to reduce the rate of evaporation as described herein.

In an implementation, a sacrificial liquid is provided in or near the head space. The sacrificial liquid is allowed to evaporate for some period of time (which, for example, may be determined empirically) to saturate the head space with vapor sourced from the sacrificial liquid and thereby reduce a rate of evaporation of the droplets in the head space. The sacrificial liquid may be provided in one or more wells formed in the top surface of the substrate, and/or one or more wells located adjacent to the substrate, and/or one or more wells surrounding an area of the top surface where the droplets are deposited. The sacrificial liquid may be provided and allowed to evaporate for a period of time prior to dispensing the droplets.

Alternatively or additionally, sacrificial liquid may be dispensed as droplets on the top surface. In such implementation, both first droplets (containing material to participate in an interaction on the top surface) and second droplets (containing the sacrificial liquid) are dispensed. The first droplets and the second droplets may be dispensed by the same liquid dispensing device or a different liquid dispensing device. The second droplets may be dispensed and allowed to evaporate for a period of time prior to dispensing the first droplets. That is, the second (sacrificial) droplets (and/or the provision of sacrificial liquid in wells) may condition the operating environment in which the first droplets are subsequently dispensed (i.e., the head space 224 of the chamber 200 shown in FIGS. 2 and 4) in a manner that reduces the rate of evaporation of liquids present in the operating environment.

In an implementation, the substrate 104 may be moved from an external position outside the space where the chamber is formed to an internal position under the cover, and moved from the internal position to an external position. That is, the chamber is formed at the internal position, and may be reformed one or more times by moving the substrate 104 back and forth.

In an implementation, the droplets are dispensed from a liquid dispensing device comprising an array of dispensing elements, and at the internal position, the substrate is aligned with the array of dispensing elements such that the dispensing of the droplets forms an array of droplets in which the droplets respectively contact predetermined addresses on the top surface.

In an implementation, the dispensing of the droplets forms or adds material to an array of spots on the top surface of the substrate. For example, the dispensing of the droplets may initiate an interaction between two or more components (e.g., reactants, precursors of synthesis, etc.). One or more of the components participating in the interaction may come from the droplets, from spots already residing on the top surface, or both.

In an implementation, depending on the application or the stage of the application being performed, the droplets dispensed may contain one or more of the following materials: a phosphoramidite, an activator reagent, a nucleotide triphosphate, a degenerate nucleotide mixture, and an enzyme. Examples of activator reagents include, but are not limited to a tetrazole, an imidazole, nitroimidazole, benzimidazole and similar nitrogen heterocyclic proton donors.

In an implementation, the flow diagram 700 may represent a chamber (e.g., chamber 200 shown in FIGS. 2, 4 and 5), or additionally a liquid dispensing device (e.g., liquid dispensing device 400 shown in FIGS. 4 and 5), or additionally a liquid dispensing system (e.g., liquid dispensing system 500 shown in FIG. 5), configured to carry out the steps shown in the flow diagram 700. For this purpose, various components of the chamber 200 and/or liquid dispensing device 400 and/or liquid dispensing system 500 may be utilized.

In any of the methods described herein, multiple steps (iterations) of liquid dispensing may be performed as needed for the specific application being implemented. For example, a method may entail dispensing first droplets, followed by dispensing second droplets. The second droplets may be deposited at the same spots 108 where the first droplets were deposited. Depending on the application, two such iterations of droplet dispensing may be performed while the substrate 104 remains in the chamber 200, or the substrate 104 may be moved outside the chamber 200 between performing the two iterations. For example, the substrate 104 may be moved back and forth between the liquid dispensing device 400 and one or more other stations (e.g., a flow station), and the chamber 200 may be re-formed, as many times as needed.

In any of the methods described herein, more than one substrate 104 may be processed simultaneously. For example, the chamber 200 may be configured to hold more than one substrate 104 simultaneously.

In an implementation, one or more steps of the methods described herein may be controlled or performed by a controller including a processor, memory, and other components as appreciated by persons skilled in the art, such as the controller 600 described above in conjunction with FIGS. 5 and 6.

In an implementation, the method for dispensing droplets may be, or be part of, a method for (bio)chemical synthesis. Such method may involve one or more steps that deposit droplets at predefined (or selected) locations on a substrate as described herein and one or more steps that apply a bulk liquid to (flow a bulk liquid into contact with) the entire top surface of the substrate. Depending on the specific method being implemented, the method may involve depositing or applying various reagents appreciated by persons skilled the art, such as those noted above.

In one example of a method for synthesizing a nucleic acid (DNA or RNA), the substrate is aligned under the dispensing elements of the liquid dispensing device and the chamber is formed thereby. Droplets containing a desired phosphoramidite in solvent are then deposited onto selected locations (e.g., a predefined array of spot sites) on the top surface of the substrate. Droplets containing an activator reagent are then deposited onto all locations where an oligonucleotide is to be extended. The deposited droplets are maintained within the chamber for the duration of the oligo extension process. As described herein, the chamber controls (slows down) the rate of evaporation of all droplets deposited in the chamber, thereby facilitating the desired interactions, in this example the interactions associated with the oligo extension process. After the oligo extension process has been completed, the substrate is moved to a different station (e.g., a flow cell station) configured to apply a bulk liquid (solution) to the entire top surface of the substrate. At this point, an appropriate solvent is applied to wash the top surface. During the course of this method, other reagents may be applied, with or without intermediate washing steps, as needed for the specific method being implemented. The substrate is then dried.

The foregoing steps are then repeated one or more times until the oligonucleotides have grown to the desired length. The substrate is now ready for use as a DNA or RNA array for further applications appreciated by persons skilled in the art. Alternatively, oligonucleotides may be cleaved from the top surface by an appropriate cleaving technique so that the cleaved oligonucleotides may be utilized individually or as part of a library, as appreciated by persons skilled in the art.

In another example, a method for synthesizing enzymatic DNA is provided. In the method, the substrate is aligned under the dispensing elements of the liquid dispensing device and the chamber is formed thereby. At this time, the substrate already includes oligonucleotides (via pre-processing) located at designated addresses (e.g., a predefined array of spot sites) on the top surface. Droplets containing a nucleotide triphosphate or a degenerate nucleotide mixture in buffer are then deposited onto at least some of the designated addresses. Droplets containing an appropriate enzyme (e.g., terminal deoxynucleotidyl transferase, or TdT) are then deposited in all locations where the oligo is to be extended to thereby add one protected nucleotide at each designated location. The deposited droplets are maintained within the chamber for the duration of the oligo extension process, with the chamber controlling the rate of evaporation in the chamber. At a different station, the substrate is washed with water, a buffer or a solvent. The substrate is then dried. During the course of this method, other reagents may be applied, with or without intermediate washing steps, as needed for the specific method being implemented.

The foregoing steps are then repeated one or more times until the oligonucleotides have grown to the desired length. The resulting, processed substrate is now ready for use as a DNA array for further applications appreciated by persons skilled in the art. Alternatively, oligonucleotides may be cleaved from the top surface by an appropriate cleaving technique so that the cleaved oligonucleotides may be utilized individually or as part of a library, as appreciated by persons skilled in the art.

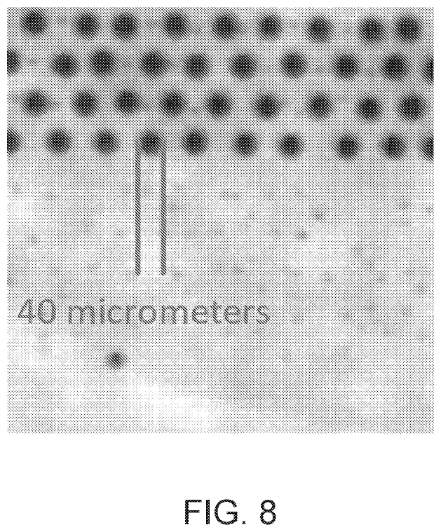

FIG. 8 is an image showing water droplets on a glass surface of a “virtual chamber” as disclosed herein. The view is from above through a window at the top of the chamber (e.g., referring to FIG. 2, looking through cover 216 to the droplets 108 on glass surface 112). Two nominally 10 picoliter drops were printed on top of each other in two passes. This image shows the dimensions of one drop roughly 40 microns in diameter, which would correspond to an about 17 picoliter hemispherical droplet, although the true shape or contact angle is not known. This image was taken 109 seconds after the start of printing the first pass of droplets. The “virtual chamber” was pre-saturated with excess sacrificial water before printing the desired droplets, as described above. Without the water-vapor-saturated “virtual chamber”, the printed droplets would evaporate completely in a few seconds.

### EXEMPLARY IMPLEMENTATIONS

Exemplary implementations provided in accordance with the presently disclosed subject matter include, but are not limited to, the following:
1. A method for dispensing droplets, the method comprising: providing a substrate comprising a top surface; positioning the substrate under a cover to form a chamber, wherein the chamber contains a head space defined between the top surface and the cover; and dispensing droplets through the head space and into contact with the top surface while the substrate is positioned in the chamber.
2. The method of implementation 1, wherein the top surface and the cover define a height of the head space, and the height is on the order of micrometers.
3. The method of implementation 1 or 2, wherein the droplets each have a volume on the order of picoliters while being dispensed and a diameter on the order of micrometers after contacting the top surface.
4. The method of any of the preceding implementations, wherein the droplets are dispensed from a liquid dispensing device comprising dispensing elements extending into the cover and into fluid communication with the head space.
5. The method of implementation 4, wherein the liquid dispensing device is a printer.
6. The method of any of the preceding implementations, wherein the chamber is partially open to an environment outside the chamber.
7. The method of any of the preceding implementations, wherein the top surface and the cover define a height of the head space, and further comprising setting the height to set a rate of evaporation of the droplets in the head space.
8. The method of any of the preceding implementations, comprising providing a sacrificial liquid in or near the head space and allowing the sacrificial liquid to evaporate to reduce a rate of evaporation of the droplets in the head space.
9. The method of implementation 8, wherein the sacrificial liquid is provided in a well of the top surface.
10. The method of implementation 8 or 9, wherein the sacrificial liquid is provided in a well located adjacent to the substrate.
11. The method of any of implementations 8-10, wherein the sacrificial liquid is provided in one or more wells surrounding an area of the top surface where the droplets are deposited.
12. The method of any of implementations 8-11, comprising providing the sacrificial liquid by dispensing droplets of the sacrificial liquid onto the top surface.
13. The method of any of the preceding implementations, wherein the droplets dispensed through the head space and into contact with the top surface are first droplets comprising a material configured to participate in an interaction on the top surface, and further comprising dispensing second droplets comprising a sacrificial liquid in or near the head space and allowing the sacrificial liquid to evaporate to reduce a rate of evaporation of the droplets in the head space.
14. The method of implementation 13, comprising operating a liquid dispensing device to dispense the first droplets, and operating the same or a different liquid dispensing device to dispense the second droplets.
15. The method of implementation 13 or 14, comprising dispensing the second droplets prior to dispensing the first droplets, and allowing the second droplets to evaporate for a period of time before dispensing the first droplets.
16. The method of any of the preceding implementations, comprising moving the substrate from an external position outside the chamber to an internal position under the cover, wherein the chamber is formed at the internal position.
17. The method of implementation 16, wherein the droplets are dispensed from a liquid dispensing device comprising an array of dispensing elements, and at the internal position, the substrate is aligned with the array of dispensing elements such that the dispensing of the droplets forms an array of droplets in which the droplets respectively contact predetermined addresses on the top surface.
18. The method of any of the preceding implementations, wherein the dispensing of the droplets forms or adds material to an array of spots on the top surface.
19. The method of any of the preceding implementations, wherein the dispensing of the droplets initiates an interaction between two or more components, and at least one of the two or more components is initially part of the droplets, or initially part of spots present on the top surface prior to the dispensing and on which the droplets are dispensed.
20. The method of any of the preceding implementations, wherein the droplets comprise a phosphoramidite.
21. The method of implementation 20, wherein the droplets comprising the phosphoramidite are first droplets deposited at predetermined spots on the top surface, and the method further comprises dispensing second droplets into contact with respective spots where the first droplets were deposited.
22. The method of implementation 21, wherein the second droplets comprise an activator reagent.
23. The method of any of implementations 20-22, further comprising applying a bulk liquid to the top surface at a location outside the chamber.
24. The method of any of implementations 21-23, comprising repeating the steps of dispensing the first droplets and the second droplets, and additional droplets and/or bulk liquids, if any, until oligonucleotides of desired lengths are synthesized on the spots.
25. The method of any of implementations 1-19, wherein the droplets comprise a nucleotide triphosphate or a degenerate nucleotide mixture.
26. The method of implementation 25, wherein the droplets comprising the nucleotide triphosphate or the degenerate nucleotide mixture are first droplets deposited at predetermined spots on the top surface, and further comprising dispensing second droplets into contact with respective spots where the first droplets were deposited.
27. The method of implementation 26, wherein the second droplets comprise an enzyme.
28. The method of any of implementations 25-27, comprising the repeating the steps of dispensing the first droplets and the second droplets, and additional droplets and/or bulk liquids, if any, until oligonucleotides of desired lengths are synthesized on the spots.
29. The method of any of implementations 1-19, wherein the droplets comprise an enzyme.
30. The method of implementation 29, wherein the droplets comprising the enzyme are first droplets deposited at predetermined spots on the top surface, and further comprising dispensing second droplets into contact with respective spots where the first droplets were deposited.
31. The method of implementation 30, wherein the second droplets comprise a nucleotide triphosphate or a degenerate nucleotide mixture.
32. The method of any of implementations 29-31, comprising repeating the steps of dispensing the first droplets and the second droplets, and additional droplets and/or bulk liquids, if any, until oligonucleotides of desired lengths are synthesized on the spots.
33. A liquid dispensing system, comprising: a cover; a substrate holder configured to hold a substrate under the cover, wherein the cover and the substrate when positioned under the cover form a chamber; and a liquid dispensing device configured to dispense droplets through the chamber and into contact with the substrate while the substrate is positioned in the chamber.
34. The liquid dispensing system of implementation 33, wherein the liquid dispensing device comprises a plurality of dispensing elements extending into the cover and into fluid communication with the chamber.
35. The liquid dispensing system of implementation 33 or 34, wherein the liquid dispensing device comprises a printer.
36. The liquid dispensing system of any of implementations 33-35, comprising a well positioned on or adjacent to the substrate, wherein the well is configured to contain an evaporable sacrificial liquid configured to reduce a rate of evaporation of the droplets dispensed by the liquid dispensing device.
37. The liquid dispensing system of any of implementations 33-36, comprising a stage configured to move the substrate holder alternately to a position under the cover to form the chamber between the substrate and the cover, and to a position outside a space at which the chamber is formed.
38. The liquid dispensing system of any of implementations 33-37, comprising a controller configured to perform or control an operation comprising one or more steps of any of implementations 1-32.
39. The liquid dispensing system of any of implementations 33-37, comprising a controller configured to perform or control an operation comprising: dispensing the droplets through the chamber and into contact with the substrate.
40. The liquid dispensing system of implementation 39, wherein the operation comprises positioning the substrate holder under the cover to form the chamber between the substrate and the cover.
41. The liquid dispensing system of implementation 39 or 40, wherein the operation comprises moving the substrate holder to a station different from the liquid dispensing device.
42. The liquid dispensing system of implementation 41, wherein the station comprises a device selected from the group consisting of: a flow cell; an analytical instrument; an imaging instrument; and a substrate washer.
43. The liquid dispensing system of any of implementations 33-42, wherein the chamber is partially open to an environment outside the chamber.
44. The liquid dispensing system of any of implementations 33-43, comprising one or more features of implementations 1-32.
45. A non-transitory computer-readable medium, comprising instructions stored thereon, that when executed on a processor, control or perform one or more of the steps of any of implementations 1-32.
46. A liquid dispensing system, comprising the non-transitory computer-readable storage medium of implementation 45.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the system controller 600 schematically depicted in FIGS. 5 and 6. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), field-programmable gate array (FPGAs), etc. Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the system controller 600 schematically depicted in FIGS. 5 and 6), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It will also be understood that the term “in signal communication” or “in electrical communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

More generally, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation-the invention being defined by the claims.

1. A method for dispensing droplets, the method comprising:
providing a substrate comprising a top surface;
positioning the substrate under a cover to form a chamber, wherein the chamber contains a head space defined between the top surface and the cover; and
dispensing droplets through the head space and into contact with the top surface while the substrate is positioned in the chamber.

2. The method of claim 1, wherein the droplets are dispensed from a liquid dispensing device comprising dispensing elements extending into the cover and into fluid communication with the head space.

3. The method of claim 1, wherein the chamber is partially open to an environment outside the chamber.

4. The method of claim 1, wherein the top surface and the cover define a height of the head space, and further comprising at least one of the following features:
wherein the method comprises setting the height to set a rate of evaporation of the droplets in the head space;
wherein the height is 1000 micrometers or less.

5. The method of claim 1, comprising, before or after dispensing the droplets, providing a sacrificial liquid in or near the head space and allowing the sacrificial liquid to evaporate to reduce a rate of evaporation of the droplets in the head space.

6. The method of claim 5, wherein the sacrificial liquid is provided in a well of the top surface.

7. The method of claim 5, wherein the sacrificial liquid is provided in a well located adjacent to the substrate.

8. The method of claim 5, wherein the sacrificial liquid is provided in one or more wells surrounding an area of the top surface where the droplets are deposited.

9. The method of claim 5, comprising providing the sacrificial liquid by dispensing the sacrificial liquid as droplets onto the top surface.

10. The method of claim 1, wherein the droplets dispensed through the head space and into contact with the top surface are first droplets comprising a material configured to participate in an interaction on the top surface, and further comprising dispensing second droplets comprising a sacrificial liquid in or near the head space and allowing the sacrificial liquid to evaporate to reduce a rate of evaporation of the droplets in the head space.

11. The method of claim 10, comprising operating a liquid dispensing device to dispense the first droplets, and operating the same or a different liquid dispensing device to dispense the second droplets.

12. The method of claim 10, comprising dispensing the second droplets prior to dispensing the first droplets.

13. The method of claim 1, comprising moving the substrate from an external position outside the chamber to an internal position under the cover, wherein the chamber is formed at the internal position.

14. The method of claim 1, wherein the droplets are dispensed from a liquid dispensing device comprising an array of dispensing elements, and the substrate is aligned with the array of dispensing elements such that the dispensing of the droplets forms an array of droplets in which the droplets respectively contact predetermined addresses on the top surface.

15. The method of claim 1, wherein the dispensing of the droplets forms or adds material to an array of spots on the top surface.

16. The method of claim 1, wherein the dispensing of the droplets initiates an interaction between two or more components, and at least one of the two or more components is initially part of the droplets, or initially part of spots present on the top surface prior to the dispensing and on which the droplets are dispensed.

17. The method of claim 1, wherein the droplets comprise a material selected from the group consisting of: a phosphoramidite; an activator reagent; a nucleotide triphosphate; a degenerate nucleotide mixture; and an enzyme.

18. A liquid dispensing system, comprising:
a cover;
a substrate holder configured to hold a substrate under the cover, wherein the cover and the substrate when positioned under the cover form a chamber; and
a liquid dispensing device configured to dispense droplets through the chamber and into contact with the substrate while the substrate is positioned in the chamber.

19. The liquid dispensing system of claim 18, wherein the liquid dispensing device comprises a plurality of dispensing elements extending into the cover and into fluid communication with the chamber.

20. The liquid dispensing system of claim 18, comprising a controller configured to perform or control an operation comprising one or more of:
dispensing the droplets through the chamber and into contact with the substrate;
positioning the substrate holder under the cover to form the chamber between the substrate and the cover;
moving the substrate holder to a station different from the liquid dispensing device.
